(19) United States
(12) Patent Application Publication
(10) Pub. No.: US 2025/0386407 A1
(43) Pub. Date: Dec. 18, 2025

(54) ELECTRONIC DEVICE

(71) Applicant: InnoLux Corporation, Miao-Li County (TW)

(72) Inventors: Yu-Shen TSAI, Miao-Li County (TW); Cheng-Hsiao LIN, Miao-Li County (TW); Sheng-Feng HUANG, Miao-Li County (TW)

(21) Appl. No.: 19/203,322

(22) Filed: May 9, 2025

(30) Foreign Application Priority Data
Jun. 13, 2024 (CN) 202410760268.9

(51) Int. Cl. H05B 45/345

(52) U.S. Cl. CPC H05B 45/345

(57) ABSTRACT

An electronic device is provided. The second transistor, the third transistor, the first capacitor and the current driving element are coupled to the first transistor. The fourth transistor writes first and second data to a control terminal of the third transistor and a control terminal of the first transistor according to first and second pulses of a first scanning signal. The second capacitor is coupled to the third transistor and a sweep signal. In a light-emitting period, the second transistor transmits a voltage signal to a first terminal of the first transistor according to an enabling signal and causes the current driving element to emit light. After the third transistor is turned on according to the sweep signal, the voltage signal is transmitted to the control terminal of the first transistor to turn off the first transistor and cause the current driving element to stop emitting light.

### CROSS REFERENCE TO RELATED APPLICATIONS

This application claims priority of China Patent Application No. 202410760268.9, filed on Jun. 13, 2024, the entirety of which is incorporated by reference herein.

### BACKGROUND OF THE DISCLOSURE

### Field of the Disclosure

The disclosure relates to an electronic device, and in particular, to an electronic device used to reduce a variation of a current magnitude or a light-emitting (duration) time when a current driving element emits light.

### Description of the Related Art

In a conventional display device, each independent pixel may control the current magnitude and the light-emitting time by writing corresponding data in a time-sharing manner. However, the current circuit architecture may cause great variations in current magnitude or a light-emitting (duration) time when the display device emits light. Therefore, a new design is needed to solve the problem described above.

### BRIEF SUMMARY OF THE DISCLOSURE

An embodiment of the disclosure provides an electronic device. The electronic device includes a first transistor, a second transistor, a third transistor, a fourth transistor, a first capacitor, a second capacitor and a current driving element. The first transistor has a first terminal, a second terminal and a control terminal. The second transistor is coupled to the first terminal of the first transistor. The third transistor has a first terminal, a second terminal and a control terminal. The first terminal of the third transistor is coupled to the first terminal of the first transistor, and the second terminal of the third transistor is coupled to the control terminal of the first transistor. The fourth transistor is coupled to the first terminal and the third transistor and configured to write first data to the control terminal of the third transistor according to a first pulse of a first scanning signal, and to write second data to the control terminal of the first transistor according to a second pulse of the first scanning signal. The first capacitor is coupled to the control terminal of the first transistor. The second capacitor has a first terminal and a second terminal. The first terminal of the second capacitor is coupled to the control terminal of the third transistor, and the second terminal of the second capacitor is coupled to a sweep signal. The current driving element is coupled to the second terminal of the first transistor. In a light-emitting period, the second transistor is configured to transmit a voltage signal to the first terminal of the first transistor according to an enabling signal and cause the current driving element to emit light, and after the third transistor is turned on according to the sweep signal, the voltage signal is transmitted to the control terminal of the first transistor to turn off the first transistor and cause the current driving element to stop emitting light.

An embodiment of the disclosure provides an electronic device, which includes a flip-flop circuit and an output circuit. The flip-flop circuit is configured to receive a first sequence pulse signal and a second sequence pulse signal, and to output an enabling signal. The output circuit is coupled to the flip-flop circuit and has an input terminal and an output terminal. The output terminal of the output circuit is configured to output a sweep signal. The output circuit includes a pull-up element, a pull-down element and a capacitor. The pull-up element includes a first transistor and a first resistor coupled to each other, wherein the first resistor is coupled to a high voltage level. The pull-down element includes a second transistor and a second resistor coupled to each other, wherein the second resistor is coupled to a low voltage level. The capacitor is coupled to the pull-up element and the pull-down element. The first resistor is different from the second resistor.

An embodiment of the disclosure provides an electronic device, which includes a special-shaped panel. The special-shaped panel includes a first area and a second area. The first area is configured to write data of a first row to a (m-1)th row, the second area is configured to write data of a mth row to a nth row, m and n are positive integers greater than 1, and n is greater than m. Through a control of a first enabling signal and a first sweep signal, the first area is configured to emit light after writing the data of the first row to the (m-1) row, and through a control of a second enabling signal and a second sweep signal, the second area is configured to emit light after writing the data of the mth row to the (n-1)th row.

### BRIEF DESCRIPTION OF THE DRAWINGS

The disclosure can be fully understood by reading the subsequent detailed description and examples with references made to the accompanying drawings, wherein:

FIG. 1 is a schematic view of an electronic device according to an embodiment of the disclosure;

FIG. 2 is a waveform diagram of a first scanning signal, a second scanning signal, an enabling signal, a sweep signal and a current flowing through a current driving element according to an embodiment of the disclosure;

FIG. 3 is a waveform diagram of a first scanning signal, a second scanning signal, first data, second data, a voltage of a node A1 and a voltage of a node B1 according to an embodiment of the disclosure;

FIG. 4 is a schematic view of an electronic device according to an embodiment of the disclosure;

FIG. 5 is a waveform diagram of a first scanning signal, a second scanning signal, a first reset signal, a second reset signal, an enabling signal, a sweep signal and a current flowing through a current driving element according to an embodiment of the disclosure;

FIG. 6 is a waveform diagram of a first scanning signal, a second scanning signal, a first reset signal, a second reset signal, first data, second data, a voltage of a node A1 and a voltage of a node B1 according to an embodiment of the disclosure;

FIG. 7 is a schematic view of an electronic device according to an embodiment of the disclosure;

FIG. 8 is a schematic view of a sequence pulse signal generating circuit according to an embodiment of the disclosure;

FIG. 9 is a waveform diagram of a first sequence pulse signal, a second sequence pulse signal and an enabling signal according to an embodiment of the disclosure;

FIG. 10 is a waveform diagram of a first sequence pulse signal, a second sequence pulse signal, a reset signal, an enabling signal and a sweep signal according to an embodiment of the disclosure;

FIG. 11 is a waveform diagram of an enabling signal and a sweep signal according to an embodiment of the disclosure;

FIG. 12 is a schematic view of an electronic device according to an embodiment of the disclosure;

FIG. 13 is a schematic view of an electronic device according to an embodiment of the disclosure; and

FIG. 14 is a timing diagram of an operation of an electronic device according to an embodiment of the disclosure.

### DETAILED DESCRIPTION OF THE DISCLOSURE

In order to make objects, features and advantages of the disclosure more obvious and easily understood, the embodiments are described below, and the detailed description is made in conjunction with the drawings. In order to help the reader to understand the drawings, the multiple drawings in the disclosure may depict a part of the entire device, and the specific components in the drawing are not drawn to scale.

The specification of the disclosure provides various embodiments to illustrate the technical features of the various embodiments of the disclosure. The configuration, quantity, and size of each component in the embodiments are for illustrative purposes, and are not intended to limit the disclosure. In addition, if the reference number of a component in the embodiments and the drawings appears repeatedly, it is for the purpose of simplifying the description, and does not mean to imply a relationship between different embodiments.

Furthermore, use of ordinal terms such as “first”, “second”, etc., in the specification and the claims to describe a claim element does not by itself connote and represent the claim element having any previous ordinal term, and does not represent the order of one claim element over another or the order of the manufacturing method, either. The ordinal terms are used as labels to distinguish one claim element having a certain name from another element having the same name.

In the disclosure, the technical features of the various embodiments may be replaced or combined with each other to complete other embodiments without being mutually exclusive.

In some embodiments of the disclosure, unless specifically defined, the term “coupled” or “electrically connected” may include any direct and indirect means of electrical connection.

In the text, the terms “substantially” or “approximately” usually means within 20%, or within 10%, or within 5%, or within 3%, or within 2%, or within 1%, or within 0.5% of a given value or range. The quantity given here is an approximate quantity. That is, without the specific description of “substantially” or “approximately”, the meaning of “substantially” or “approximately” may still be implied.

The “including” mentioned in the entire specification and claims is an open term, so it should be interpreted as “including or comprising but not limited to”.

Furthermore, “connected or “coupled” herein includes any direct and indirect connection means. Therefore, an element or layer is referred to as being “connected to” or “coupled to” another element or layer, the element or layer can be directly on, connected or coupled to another element or layer or intervening elements or layers may be present. When an element is referred to as being “directly connected to” or “directly coupled to” another element or layer, there are no intervening elements or layers present. If the text describes that a first device on a circuit is coupled to a second device, it indicates that the first device may be directly electrically connected to the second device. When the first device is directly electrically connected to the second device, the first device and the second device are connected through conductive lines or passive elements (such as resistors, capacitors, etc.), and no other electronic elements are connected between the first device and the second device.

In an embodiment, the electronic device may include a display device, a backlight device, an antenna device, a sensing device, a splicing device or a therapeutic diagnosis device, but the disclosure is not limited thereto. The electronic device may be a bendable or flexible electronic device. The display device may be a non-self-luminous type display device or a self-luminous type display device. The antenna device may be a liquid-crystal type antenna device or a non-liquid-crystal type antenna device, and the sensing device may be a sensing device that senses capacitance, light, heat or ultrasound, but the disclosure is not limited thereto. The electronic component may include a passive component and an active component, such as a capacitor, a resistor, an inductor, a diode, a transistor, etc. The diode may include a light-emitting diode or a photodiode. The light-emitting diode may include, for example, an organic light-emitting diode (OLED), a mini LED, a micro LED or a quantum dot LED, but the disclosure is not limited thereto. The splicing device may be, for example, a display splicing device or an antenna splicing device, but the disclosure is not limited thereto. It should be noted that the electronic device may be any arrangement and combination of the above devices, but the disclosure is not limited thereto. Hereinafter, the display device will be used as an electronic device to illustrate to the content of the disclosure, but the disclosure is not limited thereto.

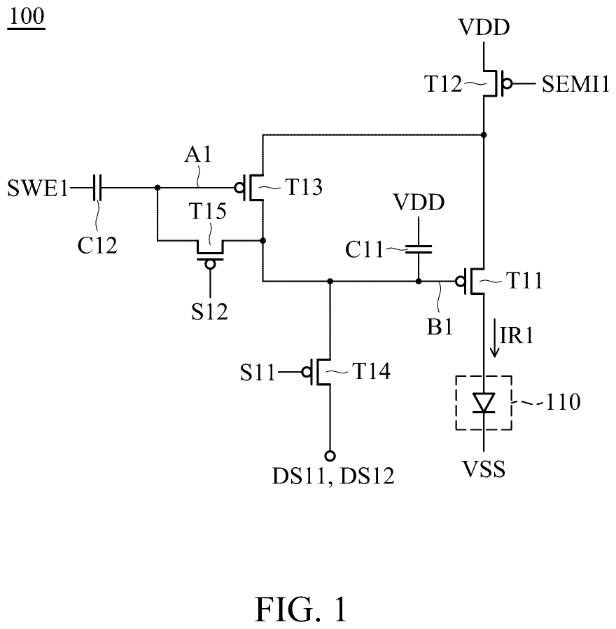

FIG. 1 is a schematic view of an electronic device according to an embodiment of the disclosure. Please refer to FIG. 1. The electronic device 100 may at least include a first transistor T11, a second transistor T12, a third transistor T13, a fourth transistor T14, a first capacitor C11, a second capacitor C12 and a current driving element 110.

The first transistor T11 may have a first terminal, a second terminal and a control terminal. The second transistor T12 may be coupled to the first terminal of the first transistor T11. Furthermore, the second transistor T12 may have a first terminal, a second terminal and a control terminal. The first terminal of the second transistor T12 may be coupled to a high voltage level VDD, wherein the high voltage level VDD is, for example, a positive voltage, but the disclosure is not limited thereto. The second terminal of the second transistor T12 may be coupled to the first terminal of the first transistor T11. The control terminal of the second transistor T12 may be coupled to an enabling signal SEMI1.

The third transistor T13 may have a first terminal, a second terminal and a control terminal. The first terminal of the third transistor T13 may be coupled to the first terminal of the first transistor T11. The second terminal of the third transistor T13 may be coupled to the control terminal of the first transistor T11.

The fourth transistor T14 may be coupled to the first transistor T11 and the third transistor T13. The fourth transistor T14 is configured to write first data DS11 to the control terminal of the third transistor T13 according to a first pulse of a first scanning signal S11, and to write second data DS12 to the control terminal of the first transistor T11 according to a second pulse of the first scanning signal S11.

The first capacitor C11 may be coupled to the control terminal of the first transistor T11. Furthermore, the first capacitor C11 may have a first terminal and a second terminal. The first terminal of the first capacitor C11 may be coupled to the control terminal of the first transistor T11. The second terminal of the first capacitor C11 may be coupled to the high voltage level VDD.

The second capacitor C12 may have a first terminal and a second terminal. The first terminal of the second capacitor C12 may be coupled to the control terminal of the third transistor T13. The second terminal of the second capacitor C12 may be coupled to the sweep signal SWE1.

The current driving element 110 may be coupled to the second terminal of the first transistor T11. Furthermore, the current driving element 110 may have a first terminal and a second terminal. The first terminal of the current driving element 110 may be coupled to the second terminal of the first transistor T11. The second terminal of the current driving element 110 may be coupled to a low voltage level VSS, wherein the low voltage level VSS is, for example, a negative voltage, but the disclosure is not limited thereto. In some embodiments, the current driving element 110 may be a light emitting diode (LED), but the disclosure is not limited thereto. In addition, the first terminal of the current driving element 110 is, for example, an anode terminal of the light emitting diode, and the second terminal of the current driving element 110 is, for example, a cathode terminal of the light emitting diode.

In some embodiments, in a light-emitting period, the second transistor T12 may transmit a voltage signal (such as the high voltage level VDD) to the first terminal of the first transistor T11 according to an enabling SEMI1 and cause the current driving element 110 to emit light, and after the third transistor T13 is turned on according to the sweep signal SWE1, the voltage signal (such as the high voltage level VDD) is transmitted to the control terminal of the first transistor T11 to turn off the first transistor T11 and cause the current driving element 110 to stop emitting light.

In some embodiments, the electronic device 100 may further include a fifth transistor T15. The fifth transistor T15 may be coupled to the control terminal and the second terminal of the third transistor T13. In addition, the fifth transistor T15 may be configured to turn on according to a second scanning signal S12. In the embodiment, the fourth transistor T14 may have a first terminal, a second terminal and a control terminal. The first terminal of the fourth transistor T14 may receive the first data DS11 and the second data DS12. The second terminal of the fourth transistor T14 may be coupled to the control terminal of the first transistor T11 and the second terminal of the third transistor T13. The control terminal of the fourth transistor T14 may receive the first scanning signal S11.

In addition, the fifth transistor T15 may have a first terminal, a second terminal and a control terminal. The first terminal of the fifth transistor T15 may be coupled to the second terminal of the third transistor T13 and the second terminal of the fourth transistor T14. The second terminal of the fifth transistor T15 may be coupled to the control terminal of the third transistor T13. The control terminal of the fifth transistor T15 may receive the second scanning signal S12.

In some embodiments, each of the first transistor T11, the second transistor T12, the third transistor T13, the fourth transistor T14 and the fifth transistor T15 may be a P-type transistor, wherein the first terminal of each of the first transistor T11, the second transistor T12, the third transistor T13, the fourth transistor T14 and the fifth transistor T15 may be a source terminal of the P-type transistor, the second terminal of each of the first transistor T11, the second transistor T12, the third transistor T13, the fourth transistor T14 and the fifth transistor T15 may be a drain terminal of the P-type transistor, and the control terminal of each of the first transistor T11, the second transistor T12, the third transistor T13, the fourth transistor T14 and the fifth transistor T15 may be a gate terminal of the P-type transistor, but the disclosure is not limited thereto. In some embodiments, each of the first transistor T11, the second transistor T12, the third transistor T13, the fourth transistor T14 and the fifth transistor T15 may be an N-type transistor or another suitable transistor.

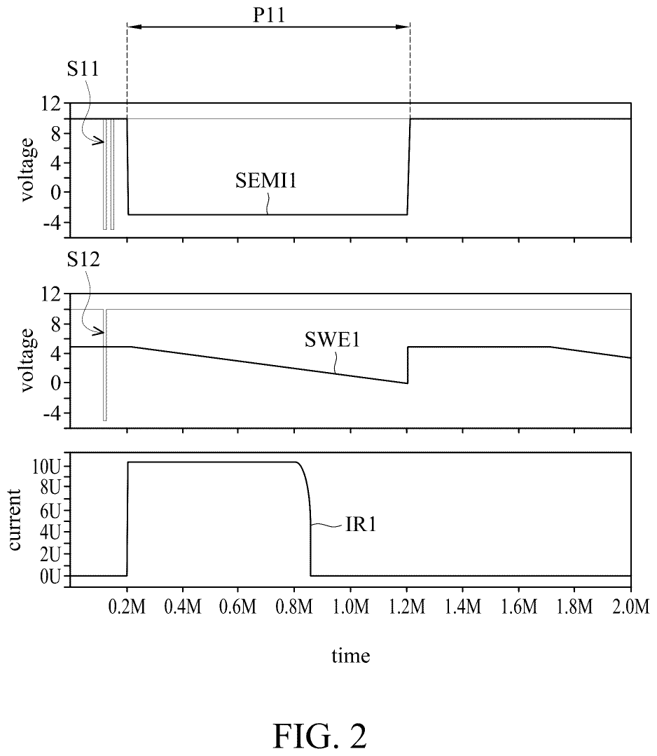

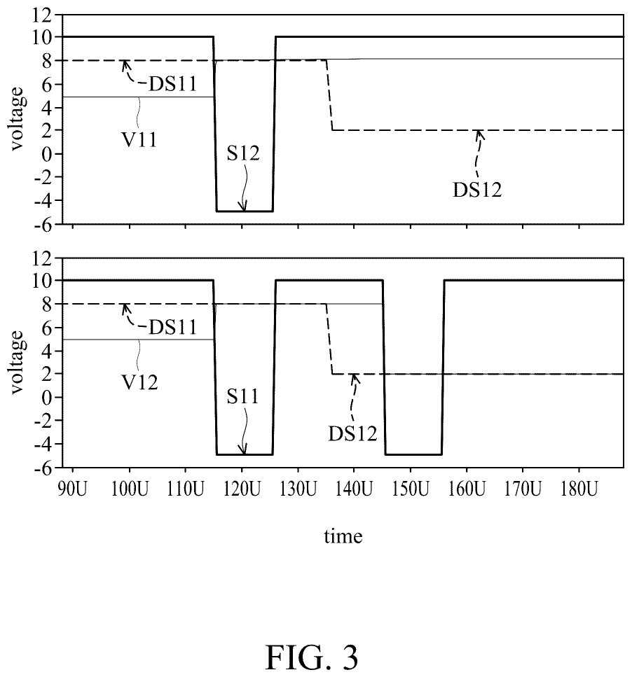

In the foregoing embodiments, the internal components and the coupling relationship thereof of the electronic device 100 are described. The operation of the electronic device 100 will be described below in conjunction with other embodiments. FIG. 2 is a waveform diagram of a first scanning signal, a second scanning signal, an enabling signal, a sweep signal and a current flowing through a current driving element according to an embodiment of the disclosure. FIG. 3 is a waveform diagram of a first scanning signal, a second scanning signal, first data, second data, a voltage of a node A1 and a voltage of a node B1 according to an embodiment of the disclosure.

In FIG. 2 and FIG. 3, the reference number S11 represents the first scanning signal, the reference number S12 represents the second scanning signal, the reference number SEMI1 represents the enabling signal, the reference number SWE1 represent the sweep signal, the reference number IR1 represents a current flowing through the current driving element 110, the reference number DS11 represents the first data, the reference number DS12 represents second data, the reference number V11 represents the voltage of the node A1, the reference number V12 represents the voltage of the node B1, and the reference P11 represents the light-emitting period. In some embodiments, the first data DS11 is 8V, the second DS12 is 2V, the high voltage level VDD is 6V, and the low voltage level VSS is −3V, but the disclosure is not limited thereto.

In an entire operation of the electronic device 100, before the light-emitting period P11, when the control terminal of the fourth transistor T14 and the control terminal of the fifth transistor T15 respectively receive, for example, the first pulse of the first scanning signal S11 with a low logic level and the second scanning signal S12 with the low logic level at the same time, the fourth transistor T14 and the fifth transistor T15 may be turned on simultaneously according to the first pulse of the first scanning signal S11 and the second scanning signal S12. At this time, the first data DS11 may be written to the control terminal of the third transistor T13 through the fourth transistor T14 and the fifth transistor T15. That is, the fourth transistor T14 may write the first data DS11 to the control terminal of the third transistor T13 according to the first pulse of the first scanning signal S11. At this time, the voltage V11 of the node A1 may be equal to the voltage level of the first data DS11.

Then, when the control terminal of the fourth transistor T14 receives, for example, the second pulse of the first scanning signal S11 with the low voltage level, the fourth transistor T14 may be turned on according to the second pulse of the first scanning signal S11. At this time, the second data DS12 may be written to the control terminal of the first transistor T11 through the fourth transistor T14. That is, the fourth transistor T14 may write the second data DS12 to the control terminal of the first transistor T11 according to the second pulse of the first scanning signal 11. At this time, the voltage V12 of the node B1 may be equal to the voltage of the second data DS12.

Afterward, in the light-emitting period P11, when the control terminal of the second transistor T12 receive, for example, the enabling signal SEMI1 with the low voltage level, the second transistor T12 may be turned on according to the enabling signal SEMI1. At this time, the voltage signal (i.e., the high voltage level VDD) may be transmitted to the first terminal of the first transistor T11 through the second transistor T12. In addition, the voltage (i.e., the high voltage level VDD) of the first terminal of the first transistor T11 is higher than the voltage (i.e., the voltage V12 of the node B1 or the voltage level of the second data DS12) of the control terminal of the first transistor T11, then the first transistor T11 may be turned on and generate a current IR1 flowing through the current driving element 110, so that the current driving element 110 emits light. That is, the second transistor T12 may transmit the voltage signal (i.e., the high voltage level VDD) to the first terminal of the first transistor T11 according to the enabling signal SEMI1 and cause the current driving element 110 to emit light.

Furthermore, when the enabling signal SEMI1 is transformed from a high voltage level to the low voltage level, the voltage level of the sweep signal SWE1 may start to change, for example, the voltage level of the sweep signal SWE1 starts to gradually become lower. Then, the sweep signal SWE1 may be coupled through the second capacitor C12, so that the voltage V11 of the node A1 gradually becomes lower. When the voltage V11 of the node A1 Is lower than the voltage of the first terminal of the third transistor T13 minus the threshold voltage of the third transistor T13, the third transistor T13 may be turned on.

At this time, the voltage signal (i.e., the high voltage level VDD) may be transmitted to the control terminal of the first transistor T11 through the third transistor T13, so that the first terminal and the control terminal of the first transistor T11 may be coupled (for example, short-circuited), then the first transistor T11 may be turned off. Since the first transistor T11 is turned off and no current IR1 is generated, the current driving element 110 may stop emitting light. That is, after the third transistor T13 is turned on according to the sweep signal SWE1, the voltage signal (such as the high voltage level VDD) is transmitted to the control terminal of the first transistor T11, so as to turn off the first transistor T11 and cause the current driving element 110 to stop emitting light.

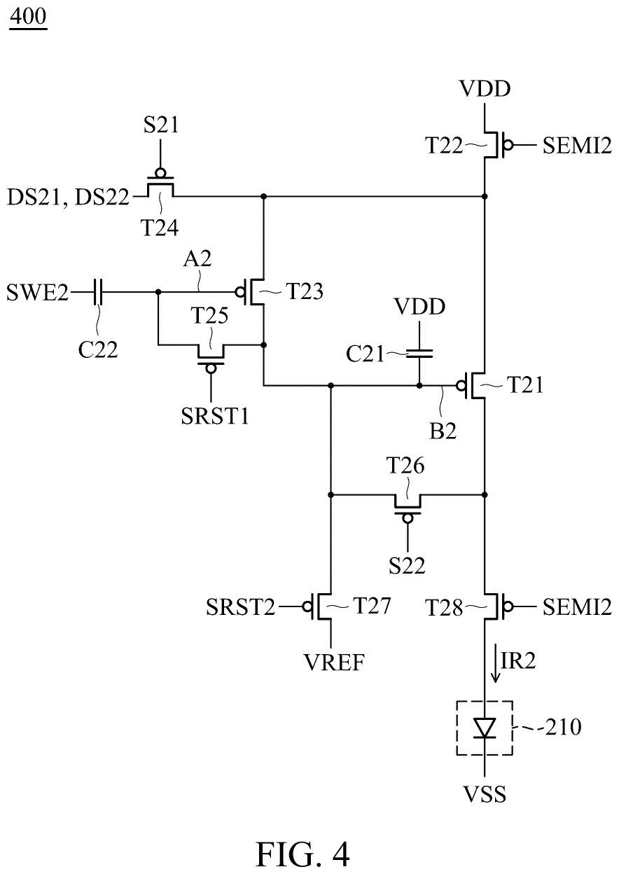

FIG. 4 is a schematic view of an electronic device according to an embodiment of the disclosure. Please refer to FIG. 4. The electronic device 400 may at least include a first transistor T21, a second transistor T22, a third transistor T23, a fourth transistor T24, a first capacitor C21, a second capacitor C22 and a current driving element 210.

The first transistor T21 may have a first terminal, a second terminal and a control terminal. The second transistor T22 may be coupled to the first terminal of the first transistor T21. Furthermore, the second transistor T22 may have a first terminal, a second terminal and a control terminal. The first terminal of the second transistor T22 may be coupled to a high voltage level VDD, wherein the high voltage level VDD is, for example, a positive voltage, but the disclosure is not limited thereto. The second terminal of the second transistor T22 may be coupled to the first terminal of the first transistor T21. The control terminal of the second transistor T22 may be coupled to an enabling signal SEMI2.

The third transistor T23 may have a first terminal, a second terminal and a control terminal. The first terminal of the third transistor T23 may be coupled to the first terminal of the first transistor T21. The second terminal of the third transistor T23 may be coupled to the control terminal of the third transistor T21.

The fourth transistor T24 may be coupled to the first transistor T21 and the third transistor T23. The fourth transistor T24 may be configured to write first data DS21 to the control terminal of the third transistor T23 according to a first pulse of a first scanning signal S21, and to write second data DS22 to the control terminal of the first transistor T21 according to a second pulse of the first scanning signal S21.

The first capacitor C21 may be coupled to the control terminal of the control terminal of the first transistor T21. Furthermore, the first capacitor C21 may have a first terminal and a second terminal. The first terminal of the first capacitor C21 may be coupled to the control terminal of the first transistor T21. The second terminal of the first capacitor C21 may be coupled to the high voltage level VDD.

The second capacitor C22 may have a first terminal and a second terminal. The first terminal of the second capacitor C22 may be coupled to the control terminal of the third transistor T23. The second terminal of the second capacitor C22 may be coupled to a sweep signal SWE2.

The current driving element 210 may be coupled to the second terminal of the first transistor T21. Furthermore, the current driving element 210 may have a first terminal and a second terminal. The first terminal of the current driving element 210 may be coupled to the second terminal of the first transistor T21. The second terminal of the current driving element 210 may be coupled to a low voltage level VSS, wherein the low voltage level VSS is a negative voltage, but the disclosure is not limited thereto. In some embodiments, the current driving element 210 may be a light emitting diode, but the disclosure is not limited thereto. In addition, the first terminal of the current driving element 210 is, for example, an anode terminal of the light emitting diode, and the second terminal of the current driving element 210 is a cathode terminal of the light emitting diode.

In some embodiments, in a light-emitting period, the second transistor T22 may transmit a voltage signal (such as the high voltage level VDD) to the first terminal of the first transistor T21 according to an enabling signal and cause the current driving element 210 to emit light, and after the third transistor T23 is turned on according to the sweep signal SWE2, the voltage signal (such as the high voltage level VDD) is transmitted to the control terminal of the first transistor T21 to turn off the first transistor T21 and cause the current driving element 210 to stop emitting light.

In some embodiments, the electronic device 400 may further include a fifth transistor T25. The fifth transistor T25 may be coupled to the control terminal and the second terminal of the third transistor T23. In addition, the fifth transistor T25 may be configured to turn on according to a first reset signal SRST1. In the embodiment, the fourth transistor T24 may have a first terminal, a second terminal and a control terminal. The first terminal of the fourth transistor T24 may receive first data DS21 and second data DS22. The second terminal of the fourth transistor T24 may be coupled to the first terminal of the first transistor T21 and the first terminal of the third transistor T23. The control terminal of the fourth transistor T24 may receive the first scanning signal S21.

In addition, the fifth transistor T25 may have a first terminal, a second terminal and a control terminal. The first terminal of the fifth transistor T25 may be coupled to the second terminal of the third transistor T23. The second terminal of the fifth transistor T25 may be coupled to the control terminal of the third transistor T23. The control terminal of the fifth transistor T25 may be receive the first reset signal SRST1.

In some embodiments, the electronic device 400 may further include a sixth transistor T26. The sixth transistor T26 may be coupled to the second terminal and the control terminal of the first transistor T21. In addition, the sixth transistor T26 may be configured to turn on according to the second scanning signal S22. In some embodiments, the electronic device 400 may further include a seventh transistor T27. The seventh transistor T27 may be coupled to the first transistor T21 and the third transistor T23. In addition, the seventh transistor T27 may be configured to provide a reference voltage VREF to the control terminal of the third transistor T23 according to a first pulse of a second reset signal SRST2, and to provide the reference voltage VREF to the control terminal of the first transistor T21 according to a second pulse of the second reset signal SRST2.

Furthermore, the seventh transistor T27 may have a first terminal, a second terminal and a control terminal. The first terminal of the seventh transistor T27 may be receive the reference voltage VREF. The second terminal of the seventh transistor T27 may be coupled to the control terminal of the first transistor T21 and the second terminal of the third transistor T23. The control terminal of the seventh transistor T27 may receive the second reset signal SRST2.

In some embodiments, the electronic device 400 may further include an eighth transistor T28. The eighth transistor T28 may be coupled between the second terminal of the first transistor T21 and the current driving element 210. In addition, the eighth transistor T28 may be configured to turn on according to the enabling signal SEMI2. Furthermore, the eighth transistor T28 may have a first terminal, a second terminal and a control terminal. The first terminal of the eighth transistor T28 may be coupled to the second terminal of the first transistor T21. The second terminal of the eighth transistor T28 may be coupled to the current driving element 210. The control terminal of the eighth transistor T28 may receive the enabling signal SEMI2.

In some embodiments, each of the first transistor T21, the second transistor T22, the third transistor T23, the fourth transistor T24, the fifth transistor T25, the sixth transistor T26, the seventh transistor T27 and the eighth transistor T28 may be a P-type transistor, wherein the first terminal of each of the first transistor T21, the second transistor T22, the third transistor T23, the fourth transistor T24, the fifth transistor T25, the sixth transistor T26, the seventh transistor T27 and the eighth transistor T28 may be a source terminal of the P-type transistor, the second terminal of each of the first transistor T21, the second transistor T22, the third transistor T23, the fourth transistor T24, the fifth transistor T25, the sixth transistor T26, the seventh transistor T27 and the eighth transistor T28 may be a drain terminal of the P-type transistor, and the control terminal of each of the first transistor T21, the second transistor T22, the third transistor T23, the fourth transistor T24, the fifth transistor T25, the sixth transistor T26, the seventh transistor T27 and the eighth transistor T28 may be a gate terminal of the P-type transistor, but the disclosure is not limited thereto. In some embodiments, each of the first transistor T21, the second transistor T22, the third transistor T23, the fourth transistor T24, the fifth transistor T25, the sixth transistor T26, the seventh transistor T27 and the eighth transistor T28 may be an N-type transistor or another suitable transistor.

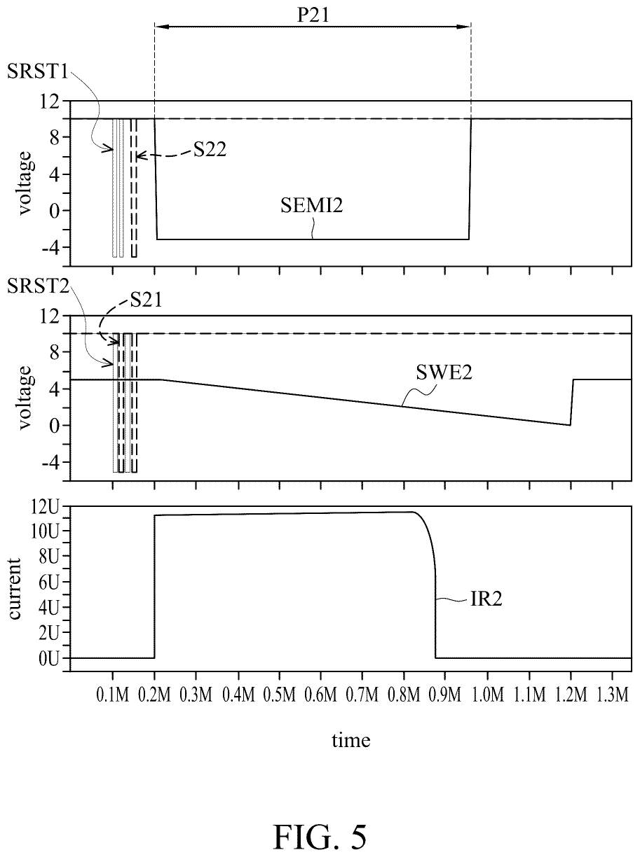

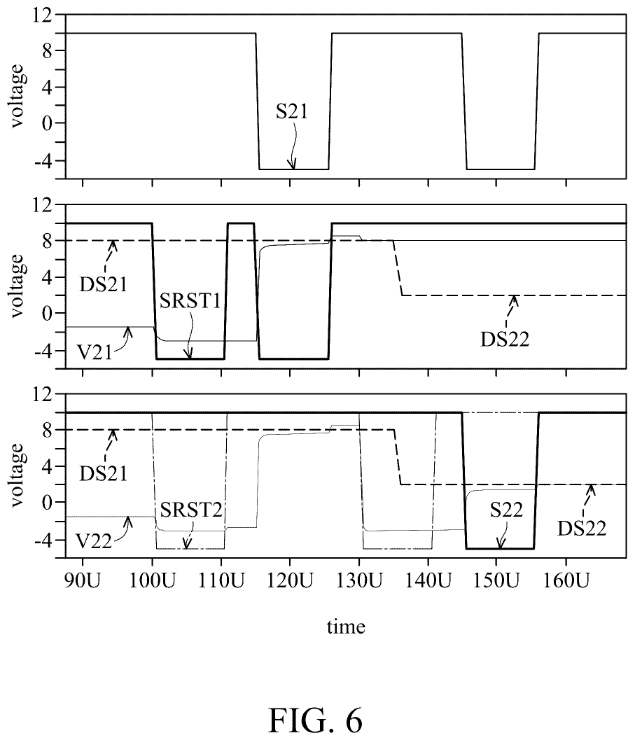

In the foregoing embodiments, the internal components and the coupling relationship thereof of the electronic device 400 are described. The operation of the electronic device 400 will be described below in conjunction with other embodiments. FIG. 5 is a waveform diagram of a first scanning signal, a second scanning signal, a first reset signal, a second reset signal, an enabling signal, a sweep signal and a current flowing through a current driving element according to an embodiment of the disclosure. FIG. 6 is a waveform diagram of a first scanning signal, a second scanning signal, a first reset signal, a second reset signal, first data, second data, a voltage of a node A1 and a voltage of a node B1 according to an embodiment of the disclosure.

In FIG. 5 and FIG. 6, the reference number S21 represents the first scanning signal, the reference number S22 represents the second scanning signal, the reference number SEMI2 represents the enabling signal, the reference number SRST1 represents the first reset signal, the reference number SRST2 represents the second reset signal, the reference number SWE2 represents the sweep signal, the reference number IR2 represents the current flowing through the current driving element 210, the reference number DS21 represents the first data, the reference number DS22 represents the second data, the reference number V21 represent the voltage of the node A2, the reference number V22 represents the voltage of the node B2, and the reference number P21 represents the light-emitting period. In some embodiments, the first data DS21 is 8V, the second data DS22 is 2V, the high voltage level VDD is 6V, the low voltage level VSS is −3V, and the reference voltage VREF is −3V, but the disclosure is not limited thereto.

In an entire operation of the electronic device 400, before the light-emitting period P21, when the control terminal of the fifth transistor T25 and the control terminal of the seventh transistor T27 respectively receive, for example, the first pulse of the first reset signal SRST1 with the low voltage level and the first pulse of the second reset signal SRST2 with the low voltage level at the same time, the fifth transistor T25 and the seventh transistor T27 may be turned on simultaneously according to the first pulse of the first reset signal SRST1 and the first pulse of the second reset signal SRST2. At this time, the reference voltage VREF may be written to the control terminal of the third transistor T23 through the fifth transistor T25 and the seventh transistor T27. That is, the seventh transistor T27 may provide the reference voltage VREF to the control terminal of the third transistor T23 according to the first pulse of the second reset signal SRST2. At this time, the voltage V21 of the node A2 may be equal to the voltage level of the reference voltage VREF.

Then, when the control terminal of the fourth transistor T24 and the control terminal of the fifth transistor T25 respectively receive, for example, the first pulse of the first scanning signal S21 with the low voltage level and the second pulse of the first reset signal SRST1 with the low voltage level, the fourth transistor T24 and the fifth transistor T25 may be turned on simultaneously according to the first pulse of the first scanning signal S21 and the second pulse of the first reset signal SRST1.

At this time, since the voltage (i.e., the voltage V21 of the node A2) of the control terminal of the third transistor T23 is lower than the voltage (i.e., the voltage level of the first data DS21) of the first terminal of the third transistor T23, the third transistor T23 is turned on. At this time, the first data DS21 may be written to the control terminal of the third transistor T23 through the fourth transistor T24, the third transistor T23 and the fifth transistor T25. That is, the fourth transistor T24 may write the first data DS21 to the control terminal of the third transistor T23 according to the first pulse of the first scanning signal S21. At this time, the voltage V21 of the node A2 may be equal to the voltage level of the first data DS21 minus the threshold voltage of the third transistor T23.

Afterward, when the control terminal of the seventh transistor T27 receives, for example, the second pulse of the second reset signal SRST2 with the low voltage level, the seventh transistor T27 may be turned on according to the second pulse of the second reset signal SRST2. At this time, the reference voltage VREF may be written to the control terminal of the first transistor T21 through the seventh transistor T27. That is, the seventh transistor T27 may provide the reference voltage VREF to the control terminal of the first transistor T21. At this time, the voltage V22 of the node B2 may be equal to the voltage level of the reference voltage VREF.

Then, when the control terminal of the fourth transistor T24 and the control terminal of the sixth transistor T26 respectively receive, for example, the second pulse of the first scanning signal S21 with the low voltage level and the second scanning signal S22 with the low voltage level at the same time, the fourth transistor T24 and the sixth transistor T26 may be turned on simultaneously according to the second pulse of the first scanning signal S21 and the second scanning signal S22. At this time, since the voltage (i.e., the voltage V22 of the node B2) of the control terminal of the first transistor T21 is lower than the voltage (i.e., the voltage level of the second data DS22) of the first terminal of the first transistor T21, the first transistor T21 is turned on. At this time, the second data DS22 may be written to the control terminal of the first transistor T21 through the fourth transistor T24, the first transistor T21 and the sixth transistor T26. That is, the fourth transistor T24 may write the second data DS22 to the control terminal of the first transistor T21 according to the first scanning signal S21. At this time, the voltage V22 of the node B2 may be equal to the voltage level of the second data DS22 minus the threshold voltage of the first transistor T21.

Afterward, in the light-emitting period P21, when the control terminal of the second transistor T22 and the control terminal of the eighth transistor T28 receive the enabling signal SEMI2 with a low voltage level at the same time, the second transistor T22 and the eighth transistor T28 may be turned on simultaneously according to the enabling signal SEMI2. At this time, the voltage signal (i.e., the high voltage level VDD) may be transmitted to the first terminal of the first transistor T21. In addition, the voltage (i.e., the high voltage level VDD) of the first terminal of the first transistor T21 is higher than the voltage (i.e., the voltage V22 of the node B2 or the voltage level of the second data DS22) of the control terminal of the first transistor T21, then the first transistor T21 may be turned on and generate a current IR2 flowing through the current driving element 210, so that the current driving element 210 emits light. That is, the second transistor T22 may transmit the voltage signal (i.e., the high voltage level VDD) to the first terminal of the first transistor T21 according to the enabling signal SEMI2 and cause the current driving element 210 to emit light.

Furthermore, when the enabling signal SEMI2 is transformed from the high voltage level to the low voltage level, the voltage level of the sweep signal SWE2 may start to change, for example, the voltage level of the sweep signal SWE2 starts to gradually become lower. Then, the sweep signal SWE2 may be coupled through the second capacitor C22, so that the voltage V21 of the node A2 gradually becomes lower. When the voltage V21 of the node A2 is lower than the voltage of the first terminal of the third transistor T23 minus the threshold voltage of the third transistor T23, the third transistor T23 may be turned on.

At this time, the voltage level (i.e., the high voltage level VDD) may be transmitted to the control terminal of the first transistor T21 through the third transistor T23, so that the first terminal and the control terminal of the first transistor T21 may be coupled (for example, short-circuited), then the first transistor T21 may be turned off. Since the first transistor T21 is turned off and no current IR2 is generated, the current driving element 210 may stop emitting light. That is, after the third transistor T23 may be turned on according to the sweep signal SWE2, the voltage signal (such as the high voltage level VDD) is transmitted to the control terminal of the first transistor T21, so as to turn off the first transistor T21 and cause the current driving element 210 to stop emitting light. Therefore, it may effectively reduce a variation of a current magnitude or a light-emitting (duration) time when the current driving element 210 emits light.

In some embodiments, the third transistor T23, the fifth transistor T25 and the seventh transistor T27 may form a first compensation unit, and the first transistor T21, the sixth transistor T26 and the seventh transistor T27 may form a second compensation unit. In addition, the first compensation unit and the second compensation unit may share the seventh transistor T27. Furthermore, the first compensation unit and the second compensation unit may be used to compensate the threshold voltages of the first transistor T21 and the third transistor T23 in the electronic device 400.

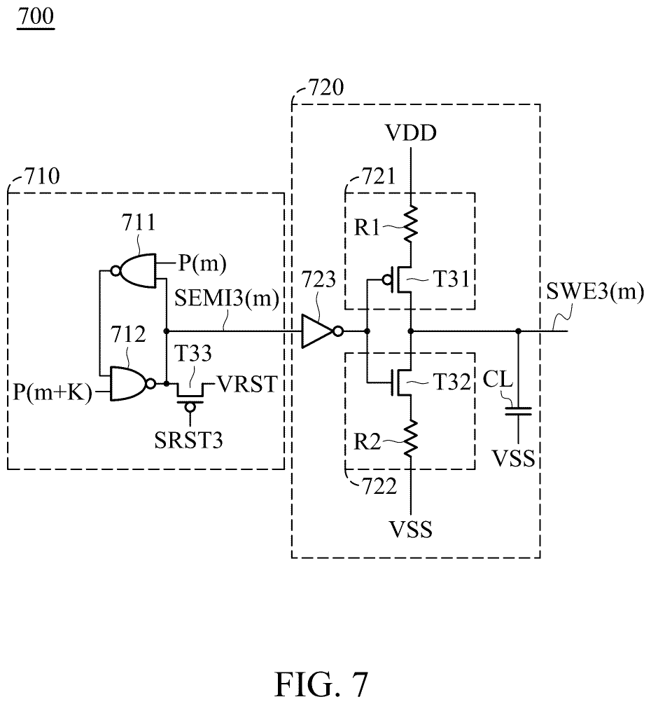

FIG. 7 is a schematic view of an electronic device according to an embodiment of the disclosure. The electronic device 700 of the embodiment may be applied to the electronic device 100 and the electronic device 400. Please refer to FIG. 7. The electronic device 700 may at least include a flip-flop circuit 710 and an output circuit 720.

The flip-flop circuit 710 may be configured to receive a first sequence pulse signal P(m) and a second sequence pulse signal P(m+k), and to output an enabling signal SEMI3(m). In some embodiments, the enabling signal SEMI3(m) may be used as the enable signal SEM 11 in FIG. 1 and the enabling signal SEMI2 in FIG. 4.

The output circuit 720 may be coupled to the flip-flop circuit 710. The output circuit 720 may have an input terminal and an output terminal. The output terminal of the output circuit 720 may be coupled to the flip-flop circuit 710 and receive the enabling signal SEMI3(m). The output terminal of the output circuit 720 may be configured to output a sweep signal SWE3(m). In some embodiments, the sweep signal SWE3(m) may be used as the sweep signal SWE1 in FIG. 1 and the sweep signal SWE2 in FIG. 4.

The output circuit 720 may include a pull-up element 721, a pull-down element 722 and a capacitor CL. The pull-up element 721 may include a first transistor T31 and a first resistor R1 coupled to each other. The first resistor R1 may be coupled to a high voltage level VDD, wherein the high voltage level VDD may be a positive voltage, but the disclosure is not limited thereto. Furthermore, the first transistor T31 may have a first terminal, a second terminal and a control terminal. The first terminal of the first transistor T31 may be coupled to the output terminal of the output circuit 720. The control terminal of the first transistor T31 may be coupled to the input terminal of the output circuit 720. The first resistor R1 may have a first terminal and a second terminal. The first terminal of the first resistor R1 may be coupled to the first terminal of the first transistor T31. The second terminal of the first resistor R1 may be coupled to the high voltage level VDD.

The pull-down element 720 may include a second transistor T32 and a second resistor R2 coupled to each other. The second resistor R2 may be coupled to a low voltage level VSS, wherein the low voltage level VSS is, for example, a negative voltage, but the disclosure is not limited thereto. Furthermore, the second transistor T32 may have a first terminal, a second terminal and a control terminal. The second terminal of the second transistor T32 may be coupled to the second terminal of the first transistor T31. The control terminal of the second transistor T32 and the control terminal of the first transistor T31. The second resistor R2 may have a first terminal and a second terminal. The first terminal of the second resistor R2 may be coupled to the first terminal of the second transistor T32. The second terminal of the second resistor R2 may be coupled to the low voltage level VSS.

The capacitor CL may be coupled to the pull-up element 721 and the pull-down element 722. Furthermore, the capacitor CL may have a first terminal and a second terminal. The first terminal of the capacitor CL may be coupled to the second terminal of the first transistor T31 (i.e., the pull-up element 721) and the second terminal of the second transistor T32 (i.e., the pull-down element 722). The second terminal of the capacitor CL may be coupled to the low voltage level VSS. In some embodiments, the capacitor CL may be an active element or a passive element, but the disclosure is not limited thereto. In some embodiments, the first resistor R1 may be different from the second resistor R2, but the disclosure is not limited thereto. In some embodiments, each of the first resistor R1 and the second resistor R2 may be an active element or a passive element, but the disclosure is not limited thereto.

In some embodiments, the flip-flop circuit 710 may include a first NAND gate 711 and a second NAND gate 712. The first NAND gate 711 may have a first input terminal, a second input terminal and an output terminal. The first terminal of the first NAND gate 711 may receive the first sequence pulse signal P(m). The second NAND gate 712 may have a first input terminal, a second input terminal and an output terminal. The first input terminal of the second NAND gate 712 may receive the second sequence pulse signal P(m+k). The second input terminal of the second NAND gate 712 may be coupled to the output terminal of the first NAND gate 711. The output terminal of the second NAND gate 712 may be coupled to the second input terminal of the first NAND gate 711 and output the enabling signal SEMI3(m).

In FIG. 7, the enabling signal SEMI3(m) is output from the output terminal of the second NAND gate 712, but the disclosure is not limited thereto. In some embodiments, an enabling signal SEMI4(m) may be output from the output terminal of the first NAND gate 711 (not shown), and the enabling signal SEMI4(m) may be a reverse signal of the enabling signal SEMI3(m).

In some embodiments, the flip-flop circuit 710 may further include a third transistor T33. The third transistor T33 may be coupled to the output terminal of the second NAND gate 712. In addition, the third transistor T33 may provide a reset voltage VRST to the output terminal of the second NAND gate 712 according to a reset signal SRST3. Furthermore, the third transistor T33 may have a first terminal, a second terminal and a control terminal. The first terminal of the third transistor T33 may receive the reset signal VRST. The second terminal of the third transistor T33 may be coupled to the output terminal of the second NAND gate 712. The control terminal of the third transistor T33 may receive the reset signal SR ST3.

In some embodiments, the output circuit 720 further includes an inverter 723. The inverter 723 may be coupled to the input terminal of the output circuit 720, the pull-up element 721 and the pull-down element 722. Furthermore, the inverter 723 may have an input terminal and an output terminal. The input terminal of the inverter 723 may be coupled to the input terminal of the output circuit 720. The output terminal of the inverter 723 may be coupled to the pull-up element 721 and the pull-down element 722.

In some embodiments, each of the first transistor T31 and the third transistor T33 may be a P-type transistor, wherein the first terminal of each of the first transistor T31 and the third transistor T33 may be a source terminal of the P-type transistor, the second terminal of each of the first transistor T31 and the third transistor T33 may be a drain terminal of the P-type transistor, and the control terminal of each of the first transistor T31 and the third transistor T33 may be a gate terminal of the P-type transistor, but the disclosure is not limited thereto. In some embodiments, each of the first transistor T31 and the third transistor T33 may be an N-type transistor or another suitable transistor.

In addition, the second transistor T32 may be an N-type transistor, wherein the first terminal of the second transistor T32 may be a source terminal of the N-type transistor, the second terminal of the second transistor T32 may be a drain terminal of the N-type transistor, and the control terminal of the second transistor T32 may be a gate terminal of the N-type transistor, but the disclosure is not limited thereto. In some embodiments, the second transistor T32 may be a P-type transistor or another suitable transistor.

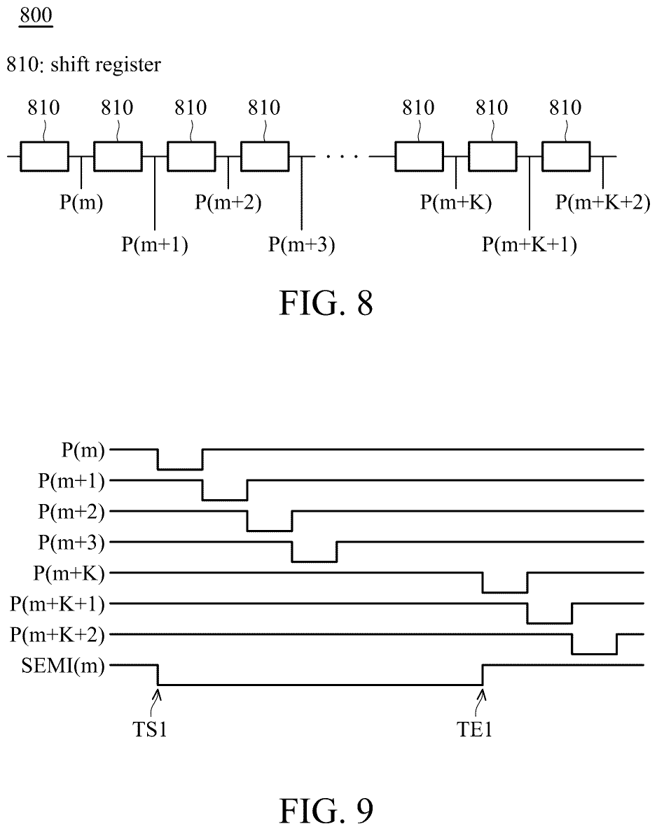

In some embodiments, the first sequence pulse signal P(m) and the second sequence pulse signal P(m+k) may be generated by a sequence pulse signal generating circuit 800, as shown in FIG. 8. FIG. 8 is a schematic view of a sequence pulse signal generating circuit according to an embodiment of the disclosure. Please refer to FIG. 8. The sequence pulse signal generating circuit 800 may include a plurality of shift registers 810. These shift registers 810 may be coupled in series, and respectively generate the first sequence pulse signals P(m), P(m+1), P(m+2) and P(m+3) and the second sequence pulse signals P(m+k), P(m+k+1) and P(m+k+2).

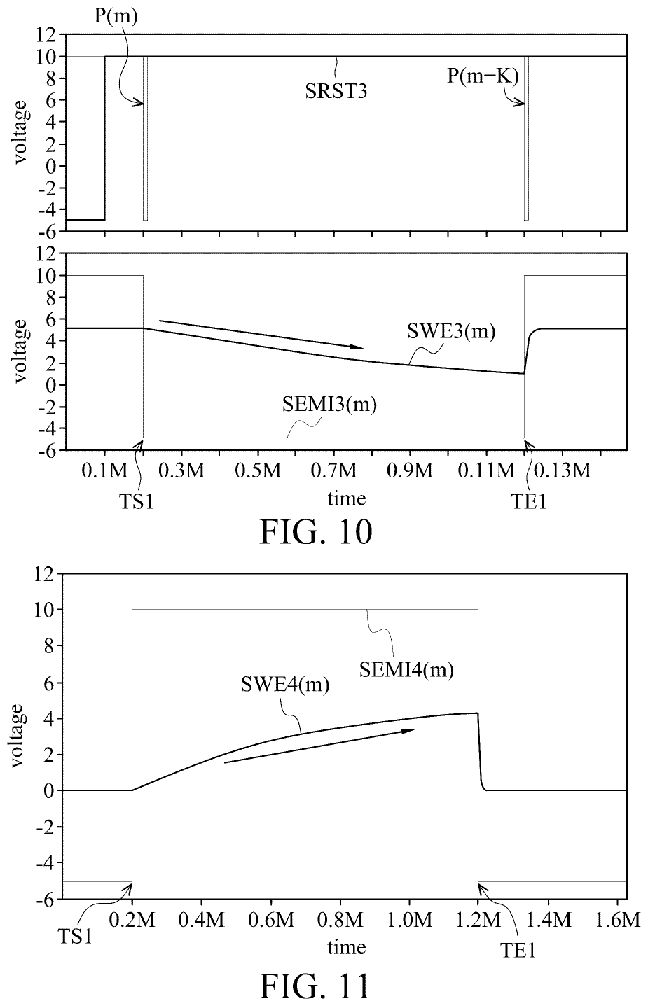

In some embodiments, the first sequence pulse signal P(m) and the second sequence pulse signal P(m+k) may be respectively used to define a starting time TS1 and an ending time TE1 of the enabling signal SEMI3(m) and the sweep signal SWE3(m), as shown in FIG. 9 and FIG. 10. Please refer to FIG. 9 and FIG. 10, the time point when the first sequence pulse signal P(m) is transformed from the high voltage level to the low voltage level may be used to define the starting time TS1 of the enabling signal SEMI3(m) and the sweep signal SWE3(m), and the time point when the second sequence pulse signal P(m+k) is transformed from the high voltage level to the low voltage level may be used to define the ending time TE1 of the enabling signal SEMI3(m) and the sweep signal SWE3(m). That is, the starting time TS1 of the enabling signal SEMI3(m) and the sweep signal SWE3(m) may be aligned, and the ending time TE1 of the enabling signal SEMI3(m) and the sweep signal SWE3(m) may be aligned.

In some embodiments, wherein when the first resistor R1 is less than the second resistor R2, the sweep signal SWE3(m) output by the output terminal of the output circuit 720 may be a downward sweep signal, as shown in FIG. 10. In some embodiments, when the first resistor R1 is greater than the second resistor R2, the sweep signal SWE4(m) output by the output terminal of the output circuit may be an upward sweep signal, as shown in FIG. 11.

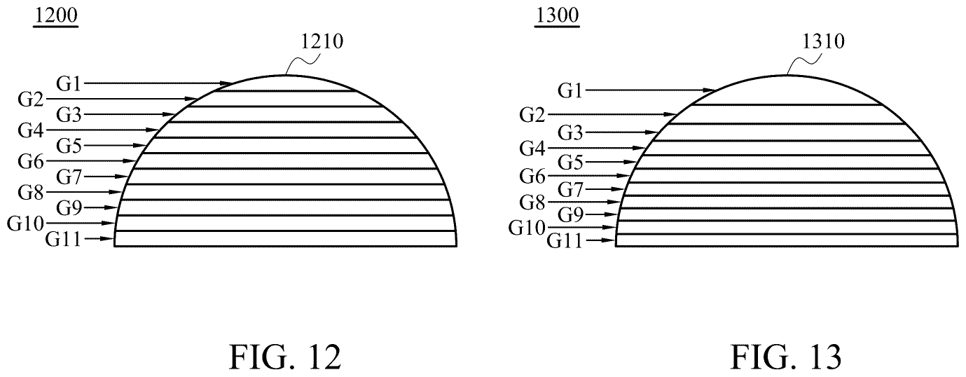

FIG. 12 is a schematic view of an electronic device according to an embodiment of the disclosure. Please refer to FIG. 12. The electronic device 1200 may include a special-shaped panel 1210. In the embodiment, the special-shaped panel 1210 may be a circular panel, but the disclosure is not limited thereto. In addition, for convenience of explanation, FIG. 12 illustrates the upper half of the special-shaped panel 1210 (such as the circular panel). The special-shaped panel 1210 may at least include a first area G1 and a second area G2. The first area G1 may write data of a first row to a (m−1)th row, and the second area G2 may write data of a (N+1)th row to a (2N)th, wherein N is a positive integer greater than 1.

In addition, through a control of a first enabling signal and a first sweep signal, the first area G1 emits light after writing the data of the first row to the Nth row, and through a control of a second enabling signal and a second sweep signal, the second area G2 emits light after writing the data of the (N+1)th row to the (2N)th row.

In the embodiment, the number of pixel rows that are included in the first area may be the same as the number of pixel rows that are included in the second area. The time at which the data is written in the first area G1 may be earlier than the time at which the data is written in the second area G2, and the first enabling signal may be earlier than the second enable signal. In addition, the starting time and the ending time of the first enabling signal and the first sweep signal may be aligned, and the starting time and the ending time of the second enabling signal and the second sweep signal.

Table 1 is a corresponding relationship of the area, the data, the pixel row, the pixel and the pixel ratio of a special-shaped panel 1210. It can be seen from Table 1 that the number of pixel rows (such as 17) of the first area G1 is the same as the number of pixel rows (such as 17) of the second area G2, and the number of pixels (such as 1868) corresponding to the first area G1 is different from the number of pixels (such as 3238) corresponding to the second area G2, and the difference is relatively large. Therefore, the same number of pixel rows corresponds to the different number of pixels, so that the resistance voltage drops (IR drops) of the first area G1 and the second area G2 are not similar, which may increase the display unevenness.

In other embodiments, the special-shaped panel 1210 includes the first area G1 and the second area G2 and may further include the areas G3˜G11. The configuration and the operation manner thereof of the areas G3˜G11 may refer to the above configuration and the operation manner of the first area G1 and the second area G2 or Table 1, and the description thereof is not repeated herein.

TABLE 1

| | | | pixel row | pixel | pixel ratio |
|---|---|---|---|---|---|
| | area | data | pcs | pcs | (%) |
| target | | | 17 | 5026 | 100.00% |
| | G1 | 1~17 | 17 | 1868 | 37.16% |
| | G2 | 18~34 | 17 | 3238 | 64.42% |
| | G3 | 35~51 | 17 | 4064 | 80.85% |
| | G4 | 52~68 | 17 | 4680 | 93.11% |
| | G5 | 69~85 | 17 | 5154 | 102.54% |
| | G6 | 86~102 | 17 | 5530 | 110.02% |
| | G7 | 103~119 | 17 | 5824 | 115.87% |
| | G8 | 120~136 | 17 | 6048 | 120.33% |
| | G9 | 137~153 | 17 | 6208 | 123.51% |
| | G10 | 154~170 | 17 | 6318 | 125.70% |
| | G11 | 171~187 | 17 | 6358 | 126.49% |

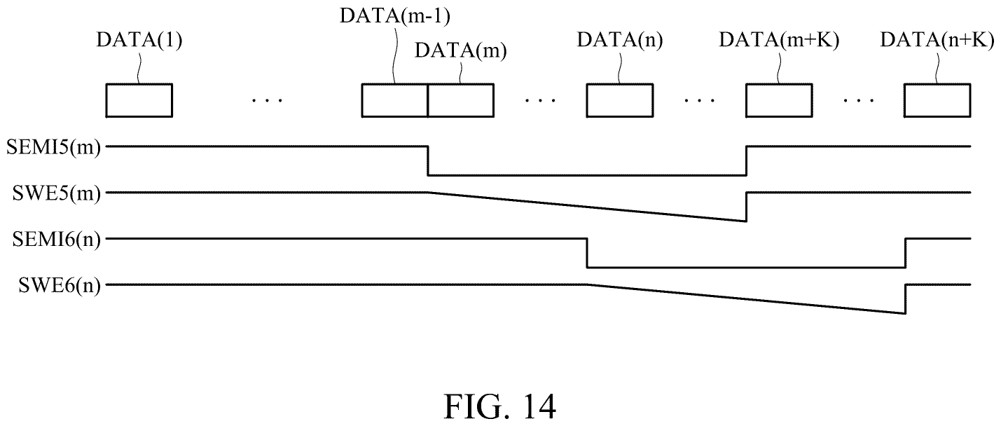

FIG. 13 is a schematic view of an electronic device according to an embodiment of the disclosure. FIG. 14 is a timing diagram of an operation of an electronic device according to an embodiment of the disclosure. Please refer to FIG. 13 and FIG. 14. The electronic device 1300 may include a special-shaped panel 1310. In the embodiment, the special-shaped panel 1310 may be a circular panel, but the disclosure is not limited thereto. In addition, for convenience of explanation, FIG. 13 illustrates the upper half of the special-shaped panel 1310 (such as the circular panel). The special-shaped panel 1310 may at least include a first area G1 and a second area G2. The first area G1 may write data DATA(1)˜DATA(m−1) of a first row to a (m−1)th row DATA(1)˜DATA(m−1), and the second area G2 may write data DATA(m)˜DATA(n) of a mth row to a nth row, wherein m and n are positive integers greater than 1, and n is greater than m.

In addition, through a control of a first enabling signal SEMI5(m) and a first sweep signal SWE5(m), the first area G1 emits light after writing the data DATA(1)˜DATA(m−1) of the first row to the (m−1) row, and through a control of a second enabling signal SEMI6(n) and a second sweep signal SWE6(n), the second area G2 emits light after writing the data DATA(m)˜DATA(n−1) of the mth row to the (n−1)th row.

In the embodiment, a number of pixel rows corresponding to the data DATA(1)˜DATA(m−1) of the first row to the (m−1)th row may be different from a number of pixel rows corresponding to the data DATA(m)˜DATA(n−1) of the mth row to the (n−1)th row. In addition, the time at which the data DATA(1)˜DATA(m−1) of the first row to the (m−1)th row is written in the first area G1 may be earlier than the time at which the data DATA(m)˜DATA(n−1) of the mth row to the (n−1)th row is written in the second area G2, and the first enabling signal SEMI5(m) may be earlier than the second enable signal SEMI6(n). In addition, the starting time and the ending time of the first enabling signal SEMI5(m) and the first sweep signal SWE5(m) may be aligned, and the starting time and the enabling signal of the second enabling signal SEMI6(n) and the second sweep signal SWE6(n) may be aligned.

Table 2 is a corresponding relationship of the area, the data, the pixel row, the pixel and the pixel ratio of the a special-shaped panel 1310. It can be seen from Table 2 that the number of pixel rows (such as 33) of the first area G1 is different from the number of pixel rows (such as 21) of the second area G2, and the number of pixels (such as 4890) corresponding to the first area G1 is similar to the number of pixels (such as 5066) corresponding to the second area G2. Therefore, the different number of pixel rows corresponds to the similar number of pixels, so that the resistance voltage drops (IR drops) of the first area G1 and the second area G2 may be similar, so as to reduce the display unevenness.

In other embodiments, the special-shaped panel 1310 includes the first area G1 and the second area G2 and may further include the areas G3˜G11. The configuration and the operation manner thereof of the areas G3˜G11 may refer to the above configuration and the operation manner of the first area G1 and the second area G2 or Table 2, and the description thereof is not repeated herein.

TABLE 2

| | | | pixel row | pixel | pixel ratio |
|---|---|---|---|---|---|
| | area | data | pcs | pcs | (%) |
| target | | | 17 | 5026 | 100.00% |
| | G1 | 1~33 | 33 | 4890 | 97.29% |
| | G2 | 34~54 | 21 | 5066 | 100.79% |
| | G3 | 55~72 | 18 | 5068 | 100.83% |
| | G4 | 73~88 | 16 | 4932 | 98.12% |
| | G5 | 89~103 | 15 | 4914 | 97.76% |
| | G6 | 104~118 | 15 | 5138 | 102.22% |
| | G7 | 119~132 | 14 | 4958 | 98.64% |
| | G8 | 133~146 | 14 | 5076 | 100.99% |
| | G9 | 147~160 | 14 | 5164 | 102.74% |
| | G10 | 161~174 | 14 | 5222 | 103.89% |
| | G11 | 175~187 | 13 | 4862 | 96.73% |

In summary, according to the electronic device disclosed by the embodiments of the disclosure, the second transistor is coupled to the first terminal of the first transistor. The first terminal of the third transistor is coupled to the first terminal of the first transistor. The second terminal of the third transistor is coupled to the control terminal of the first transistor. The fourth transistor is coupled to the first terminal and the third transistor, and configured to write the first data to the control terminal of the third transistor according to the first pulse of the first scanning signal, and to write the second data to the control terminal of the first transistor according to the second pulse of the first scanning signal. The first capacitor is coupled to the control terminal of the first transistor. The first terminal of the second capacitor is coupled to the control terminal of the third transistor. The second terminal of the second capacitor is coupled to the sweep signal. The current driving element is coupled to the second terminal of the first transistor. In the light-emitting period, the second transistor transmits the voltage signal to the first terminal of the first transistor according to the enabling signal and cause the current driving element to emit light, and after the third transistor is turned on according to the sweep signal, the voltage signal is transmitted to the control terminal of the first transistor to turn off the first transistor and cause the current driving element to stop emitting light.

In addition, the electronic device of the embodiment of the disclosure may further include the flip-flop circuit and the output circuit. The flip-flop circuit receives the first sequence pulse signal and the second sequence pulse signal, and outputs the enabling signal. The output circuit outputs the sweep signal according to the enabling signal. Therefore, it may effectively generate the suitable enabling signal and the suitable sweep signal.

Furthermore, the electronic device of the embodiment of the disclosure may further include the special-shaped panel, the special-shaped panel includes the first area and the second area, the first area writes the data of the first row to the (m−1)th row, the second area writes the data of the mth row to the nth row. Through the control of the first enabling signal and the first sweep signal, the first area emits light after writing the data of the first row to the (m−1) row, and through the control of the second enabling signal and the second sweep signal, the second area emits light after writing the data of the mth row to the (n−1)th row. The number of pixel rows corresponding to the data of the first row to the (m−1)th row is different from the number of pixel rows corresponding to the data of the mth row to the (n−1)th row, and the different number of pixel rows corresponds to the similar number of pixels. Therefore, the resistance voltage drops (IR drops) of the first area and the second area may be similar, so as to reduce the display unevenness.

While the disclosure has been described by way of examples and in terms of the preferred embodiments, it should be understood that the disclosure is not limited to the disclosed embodiments. On the contrary, it is intended to cover various modifications, combinations, and similar arrangements (as would be apparent to those skilled in the art). Therefore, the scope of the appended claims should be accorded the broadest interpretation to encompass all such modifications, combinations, and similar arrangements.

What is claimed is:

1. An electronic device, comprising:
a first transistor, having a first terminal, a second terminal and a control terminal;
a second transistor, coupled to the first terminal of the first transistor;
a third transistor, having a first terminal, a second terminal and a control terminal, wherein the first terminal of the third transistor is coupled to the first terminal of the first transistor, and the second terminal of the third transistor is coupled to the control terminal of the first transistor;
a fourth transistor, coupled to the first terminal and the third transistor, and configured to write first data to the control terminal of the third transistor according to a first pulse of a first scanning signal, and to write second data to the control terminal of the first transistor according to a second pulse of the first scanning signal;
a first capacitor, coupled to the control terminal of the first transistor;
a second capacitor, having a first terminal and a second terminal, wherein the first terminal of the second capacitor is coupled to the control terminal of the third transistor, and the second terminal of the second capacitor is coupled to a sweep signal;
a current driving element, coupled to the second terminal of the first transistor;
wherein in a light-emitting period, the second transistor is configured to transmit a voltage signal to the first terminal of the first transistor according to an enabling signal and cause the current driving element to emit light, and after the third transistor is turned on according to the sweep signal, the voltage signal is transmitted to the control terminal of the first transistor to turn off the first transistor and cause the current driving element to stop emitting light.

2. The electronic device according to claim 1, further comprising:
a fifth transistor, coupled to the control terminal and the second terminal of the third transistor.

3. The electronic device according to claim 2, wherein the fifth transistor is configured to turn on according to a second scanning signal.

4. The electronic device according to claim 2, wherein the fifth transistor is configured to turn on according to a first reset signal.

5. The electronic device according to claim 2, further comprising:
a sixth transistor, coupled to the second terminal and the control terminal of the first transistor.

6. The electronic device according to claim 5, wherein the sixth transistor is configured to turn on according to a second scanning signal.

7. The electronic device according to claim 5, further comprising:
a seventh transistor, coupled to the first transistor and the third transistor.

8. The electronic device according to claim 7, wherein the seventh transistor is configured to provide a reference voltage to the control terminal of the transistor according to a first pulse of a second reset signal, and to provide the reference voltage to the control terminal of the first transistor according to a second pulse of the second reset signal.

9. The electronic device according to claim 7, further comprising:
an eighth transistor, coupled between the second terminal of the first transistor and the current driving element.

10. The electronic device according to claim 9, wherein the eighth transistor is configured to turn on according to the enabling signal.

11. An electronic device, comprising:
a flip-flop circuit, configured to receive a first sequence pulse signal and a second sequence pulse signal, and to output an enabling signal;
an output circuit, coupled to the flip-flop circuit and having an input terminal and an output terminal, wherein the output terminal of the output circuit is configured to output a sweep signal, and the output circuit comprises:
a pull-up element, comprising a first transistor and a first resistor coupled to each other, wherein the first resistor is coupled to a high voltage level;
a pull-down element, comprising a second transistor and a second resistor coupled to each other, wherein the second resistor is coupled to a low voltage level;
a capacitor, coupled to the pull-up element and the pull-down element;
wherein the first resistor is different from the second resistor.

12. The electronic device according to claim 11, wherein the flip-flop circuit comprises:
a first NAND gate, having a first input terminal, a second input terminal and an output terminal, wherein the first terminal of the first NAND gate is configured to receive the first sequence pulse signal;
a second NAND gate, having a first input terminal, a second input terminal and an output terminal, wherein the first input terminal of the second NAND gate is configured to receive the second sequence pulse signal, the second input terminal of the second NAND gate is coupled to the output terminal of the first NAND gate, and the output terminal of the second NAND gate is coupled to the second input terminal of the first NAND gate and configured to output the enabling signal.

13. The electronic device according to claim 12, wherein the flip-flop circuit further comprises:
a third transistor, coupled to the output terminal of the second NAND gate, and configured to provide a reset voltage to the output terminal of the second NAND gate according to a reset signal.

14. The electronic device according to claim 11, wherein the output circuit further comprises:
an inverter, coupled to the output terminal of the output circuit, the pull-up element and the pull-down element.

15. The electronic device according to claim 11, wherein the first sequence pulse signal and the second sequence pulse signal are configured to define a starting time and an ending time of the enable signal and the sweep signal, respectively.

16. The electronic device according to claim 11, wherein when the first resistor is less than the second resistor, the sweep signal output by the output terminal of the output circuit is a downward sweep signal.

17. The electronic device according to claim 11, wherein when the first resistor is greater than the second resistor, the sweep signal output by the output terminal of the output circuit is an upward sweep signal.

18. An electronic device, comprising:
a special-shaped panel, comprising a first area and a second area, wherein the first area is configured to write data of a first row to an (m−1)th row, the second area is configured to write data of an mth row to an nth row, wherein m and n are positive integers greater than 1, and n is greater than m;
wherein through a control of a first enabling signal and a first sweep signal, the first area is configured to emit light after writing the data of the first row to the (m−1) row, and through a control of a second enabling signal and a second sweep signal, the second area is configured to emit light after writing the data of the mth row to the (n−1)th row.

19. The electronic device according to claim 18, wherein a number of pixel rows corresponding to the data of the first row to the (m−1)th row is different from a number of pixel rows corresponding to the data of the mth row to the (n−1)th row.

20. The electronic device according to claim 18, wherein a time at which the data of the first row to the (m−1)th row is written in the first area is earlier than the time at which the data of the mth row to the (n−1)th row is written in the second area, and the first enabling signal is earlier than the second enable signal.
